(19) United States
(12) Patent Application Publication
(10) Pub. No.: US 2023/0285993 A1
(43) Pub. Date: Sep. 14, 2023

(54) Condensate Recovery System for Volatized Insect Repellent

(71) Applicant: Thermacell Repellents, Inc., Bedford, MA (US)

(72) Inventors: Stephen J. Shapiro, Bedford, MA (US); Wender Wang, Bedford, MA (US)

(73) Assignee: Thermacell Repellents, Inc., Bedford, MA (US)

(21) Appl. No.: 18/018,368

(22) PCT Filed: Jul. 27, 2021
(86) PCT No.: PCT/US21/70978

§ 371 Date: Jan. 27, 2023

Related U.S. Application Data
(60) Provisional application No. 63/056,947, filed on Jul. 27, 2020.

(51) Int. Cl. B05B 1/28; A01M 29/12; B05B 1/24

(52) U.S. Cl. CPC B05B 1/28; A01M 29/12; B05B 1/24

(57) ABSTRACT

An insect repelling device includes abase and a cap. The base supports a fluid reservoir containing a vaporizable insect repelling fluid. The cap has an exhaust port that permits a vapor of the insect repelling fluid to be emitted. The cap permits condensation of the insect repelling fluid vapors of the insect repelling fluid to flow toward the exhaust port.

### CROSS-REFERENCE TO RELATED APPLICATIONS

This application claims the benefit of U.S. Provisional Application No. 63/056,947, filed Jul. 27, 2020, the disclosure of which is incorporated herein by reference in its entirety.

### BACKGROUND OF THE INVENTION

This invention relates in general to insect repelling devices, and more particularly to directing condensed repellent material for reuse.

Ridding areas of unwanted insects has been a common goal where people congregate to promote health by preventing disease transmission from and allergic reactions to insect bites. Many devices have been used to trap and/or kill insects; however, these devices are either ineffective, unattractive, or potentially harmful. Many devices that kill insects rely on attracting them to a device which can be counterproductive to eliminating these pests from groups of people. Certain plant species are known to trap and kill insects, such as the Venus Fly Trap (Dionaea muscipula), or repel insects, such as Marigolds and Chrysanthemums. Insect repelling plants typically produce compounds that create scents undesirable to certain insects. Other materials derived from plants, such as citronella, are also used to repel insects. Plants do require maintenance and the necessary environmental conditions to survive which limits their usefulness.

Insect repellent devices are used to emit a material or substance that directs insects away from areas where people congregate. Such devices range from simple citronella-infused candles to sophisticated devices that volatize chemicals known to disperse insects and are not harmful to people. Devices that volatize and disperse insect repellent materials provide the ability to effectively control insect levels in the nearby environment without creating an annoyance to people in the area. Typically, heat is used in the volatizing process and natural or forced convection disperses the material. One drawback to volatizing a compound with heat is that the emission material may condense on cooler surfaces, particularly on surfaces of the dispensing unit. The condensate can be a handling concern in so far as it may stain or drip onto other items and represents repellent material that is lost, reducing the efficiency of the device. Thus, it would be desirable to redirect any condensation of insect repellent back into the device for capture and re-vaporization into the air.

### SUMMARY OF THE INVENTION

This invention relates to insect repelling devices that vaporize and emit insect repelling compounds. This invention more particularly relates to an insect repelling device having features that redirect condensed repellent material for reuse.

An insect repelling device comprises a base configured to support a fluid reservoir containing an insect repelling fluid. A cap is mounted on the base and has an exhaust port that permits a vapor of the insect repelling fluid to be emitted. The cap is configured to permit a condensate of the insect repelling fluid to flow toward the exhaust port. A wick extends from the fluid reservoir to a heating element that vaporizes the insect repelling fluid from the wick. In one aspect of the invention, a chimney is positioned between the heating element and the cap and extends through the exhaust port to define a condensate drainage path to one of the wick or the heating element. The upper surface of the cap is sloped toward the exhaust port. In another feature of the various embodiments of the invention, the cap may include at least one opening configured to permit a condensate of the insect repelling fluid to flow toward at least one of the wick or the heating element.

An insect repelling device comprises a base configured to support a fluid reservoir containing an insect repelling fluid. A cap is mounted on the base and has an exhaust port that permits a vapor of the insect repelling fluid to be emitted. The cap is configured to permit a condensate of the insect repelling fluid to flow toward the exhaust port. A wick extends from the fluid reservoir to a heating element that vaporizes the insect repelling fluid from the wick. In another aspect of the invention, the heating element includes a heater housing having an exhaust extension that extends coaxially through the exhaust port. A chimney is positioned coaxially within the exhaust extension and extends through the exhaust port. The exhaust extension and chimney cooperate to define a condensate drainage path to one of the wick or the heating element.

An insect repelling device comprises a base and an upper section. The base supports a fluid reservoir containing an insect repelling fluid and a wick extending from the fluid reservoir. The upper section includes a heating assembly and cap with an exhaust port that permits a vapor of the insect repelling fluid to be emitted. The cap defines a condensate drainage path between the heating assembly and the exhaust port to permit a condensate of the insect repelling fluid to flow toward the exhaust port. The cap defines a concave, sloped surface extending toward the exhaust port. A chimney is coaxially positioned above the wick and extends through the exhaust port, the chimney and the exhaust port cooperate to define the condensate drainage path therebetween. In certain aspects of the invention, the chimney includes a flange that cooperates with the cap to retain the chimney to the upper section. A sealing element may extend between the cap and a portion of the heating assembly to prevent the condensate from migrating away from the wick.

In an alternative embodiment of an insect repelling device, a base supports a fluid reservoir containing an insect repelling fluid and a wick extending from the fluid reservoir. An upper section includes a heating assembly and cap with an exhaust port that permits a vapor of the insect repelling fluid to be emitted. The cap defines a condensate drainage path between the heating assembly and the exhaust port to permit a condensate of the insect repelling fluid to flow toward the exhaust port. The heating assembly includes an exhaust extension extending from a heater housing through the exhaust port, the exhaust extension including an edge radius and a bore, the cap defining a concave, sloped surface extending toward the exhaust port.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a cross sectional, elevation view of a prior art repeller device.

FIG. 2 is an enlarged, cross sectional, elevation view of the prior art repeller device of FIG. 1.

FIG. 3A is a cross sectional, elevation view of an embodiment of a repeller in accordance with the invention.

FIG. 3B is an enlarged view of a chimney section of the repeller of FIG. 3A.

FIG. 3C is a perspective view of the evaporative dispenser bottle shown in dashed lines as part of the repeller of FIG. 3A.

FIG. 4 is an enlarged, perspective view, in cross section, of an upper portion of the repeller of FIG. 3.

FIG. 5A is an exploded view of another embodiment of a repeller in accordance with the invention.

FIG. 5B is an enlarged, cross sectional view of a portion of the repeller of FIG. 5A.

FIG. 6A is an enlarged, cross sectional view of a portion of yet another embodiment of a repeller in accordance with the invention.

FIG. 6B is an enlarged portion of a lid and chimney interface section of the repeller of FIG. 6A.

### DETAILED DESCRIPTION OF THE PREFERRED EMBODIMENT

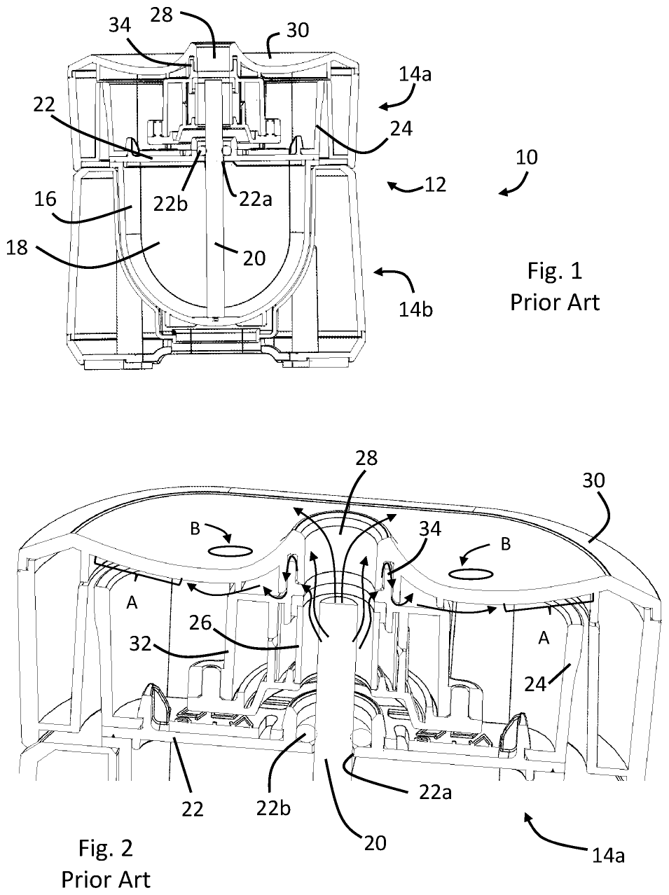

Referring now to the drawings, there is illustrated in FIGS. 1 and 2 a prior art insect repeller device, shown generally at 10. The repeller 10 includes a housing 12 having a lid section 14a and a base section 14b that supports an evaporative fluid bottle 16 having a fluid reservoir 18 with a wick 20 extending outwardly therefrom. The fluid reservoir 18 includes a cap 22 having a wick port 22a through which the wick 20 passes and a seal, illustrated as an O-ring 22b. In the illustrated embodiment, the rigid, porous wick extends into the contents contained within the fluid reservoir, and further extends through a seal and into a heating element configured as a cylindrical heater. A bottle support 24 extends from the cap 22 into the lid section 14a to prevent movement of the bottle 16 when the lid section 14a is attached to the base section 14b. A heating element 26 encircles the wick 20 in order to volatize fluid in the bottle 16. As the wick draws fluid due to a wicking or capillary action, the heating element volatizes the fluid and emits vapors through an exhaust port 28 formed in an upper cap 30 of the lid section. To prevent user contact with heated surfaces, the upper cap 30 of the lid section is spaced apart from the heating element 26 by a heater housing 32 and an air gap. This helps to maintain the lid section at a cooler temperature than the area surrounding the wick. The heater housing 32 includes an exhaust collar 34 that is aligned with the exhaust port 28 to center the opening around the wick for facilitating vapor flow from the unit.

As shown in FIG. 2, the wick 20 emits vapors of volatized insect repellent, shown by the arrows, into the atmosphere. Ideally, these vapors are completely expelled from the unit 10. In practice, the degree of vaporization is not entirely constant and some vapors are heavier or more dense and do not travel far from the unit. Other vapors find their way through passages in the assembly of components forming the lid section 14a. These vapors condense on the inside surface of the lid section such as in areas A and/or pool on the outer surface such as in areas B. The condensed material becomes a handling and transport concern as the pooled material may contact other items or people.

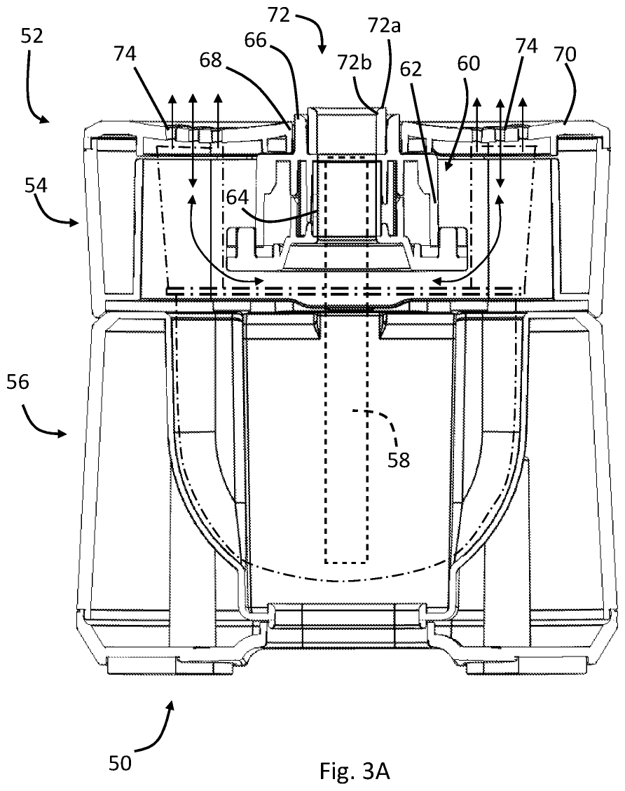

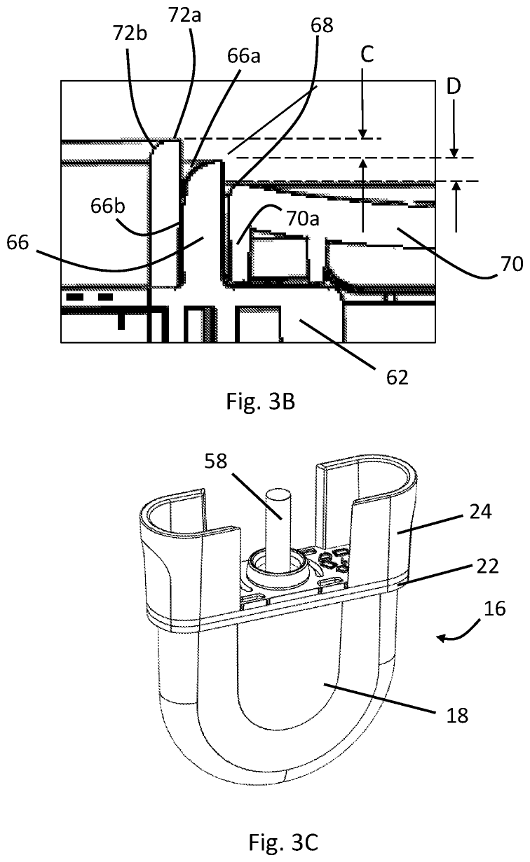

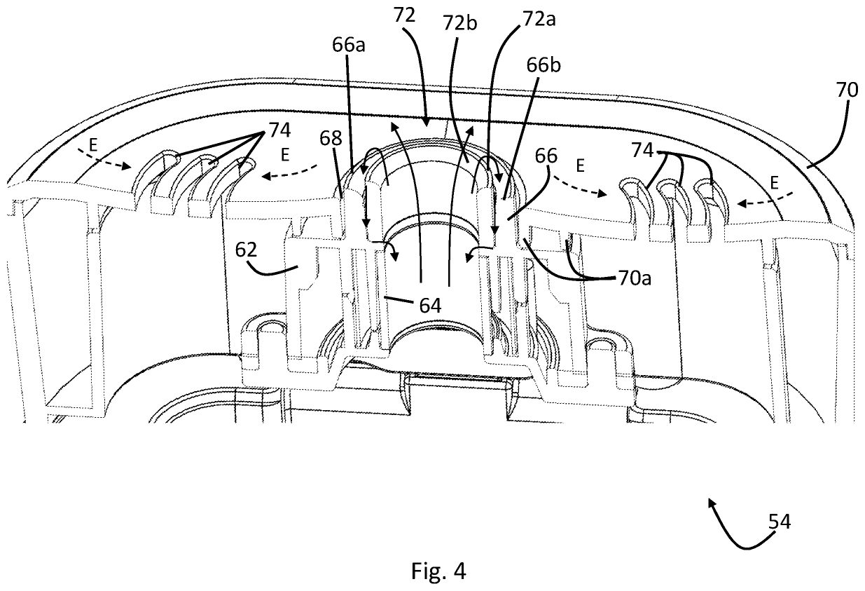

Referring now to FIGS. 3A-3C and 4, there is illustrated an insect repeller device, shown generally at 50, in accordance with an embodiment of the invention that provides a condensate ventilation and drainage system to redirect condensed material back to the wick. The insect repeller device 50 includes a housing 52 comprising a lid section 54 and a base section 56. The base section 56 is similar to base section 14b and supports the evaporative fluid bottle 16 and a wick 58. The wick 58 may be formed from a sintered polyester material that provides an improved material draw from the reservoir as the fluid level decreases. This improved fluid draw, by way of capillary action, maintains more material in the heating element region to provide better volatilization of repellent material. Other wick materials such as wood fiber, cotton fiber or other capillary action conducive materials may be used if desired.

The wick 58 extends through a heating assembly 60 which includes a heater housing 62 that supports a heating element 64, similar to heating element 26. The heater housing 62 includes an exhaust extension 66 that extends coaxially through an exhaust port 68 formed in an upper cap 70 of the lid section 54. As shown in FIG. 3B, the exhaust extension 66 extends beyond the exhaust port and coaxially supports a chimney, shown generally at 72. The chimney 72 extends above both the exhaust port 68 and the exhaust extension 66. In one aspect of the embodiment of the repeller 50, the chimney 72 defines an exit edge 72a having a radius 72b, illustrated as a convex or bullnose oriented radius, though the exit edge may be chamfered. As also shown in FIG. 3B, the exhaust extension 66 includes an edge radius 66a and a bore 66b that supports the chimney 72. The bore 66b may be smooth or fluted but defines a condensate drain path 66c between the exhaust extension 66 and the chimney 72 that directs condensate or condensing vapor back towards the heating element 64. The chimney 72 may be located and secured within the exhaust extension 66 at one or more discrete locating points contacting the outer diameter of the chimney 72. An uppermost point or surface of the exit edge 72a of the chimney 72 defines a first height C that is about 1.5 mm above the uppermost point of the edge radius 66a. The exhaust port 68 of the upper cap 70 may include a chamfered edge 68a defining a second height D that is about 1.0 to 1.5 mm below the uppermost point of the edge radius 66a of the exhaust extension 66. This relative positioning of exhaust components is a factor in minimizing condensate formation and collection on various parts of the unit 50.

As shown in FIGS. 3A, 3B, and 4, the upper cap 70 includes at least one support leg 70a that encircles the exhaust extension 66 and contacts and seals against the heater housing 62. The seal may consist of a bonded attachment (adhesive, tape, or heat bond) or tight fit between the support leg 70a and the heater housing 62 or may include a separate sealing element such as an O-ring, X-ring, lip seal or other sealing member as will be described below. In the illustrated embodiment, the upper cap 70 includes at least one vent 74, six vents are shown, that permits vapor emitted from the wick between the cap 22 and the heater housing 62 to exit and also permit movement of air in and out of the space under the upper cap 70. The upper cap 70 is illustrated having a dished shape, E with a low spot in the vicinity of the vents 74. The dished shape permits heavier vapors that would form condensate more readily to be conducted toward the wick by convective currents generated from the heating element 64 and the chimney effect from the cooperation of the chimney 72, the exhaust extension 66 and the exhaust port 68 based on their relative positioning as described previously. In thermal environments where convective currents may be generated in a reverse flow, the vents 74 may operate to permit breathing of the device such that air may move through the device in both an intake and an exhaust direction in response to thermally generated pressure differentials within the lid section 54.

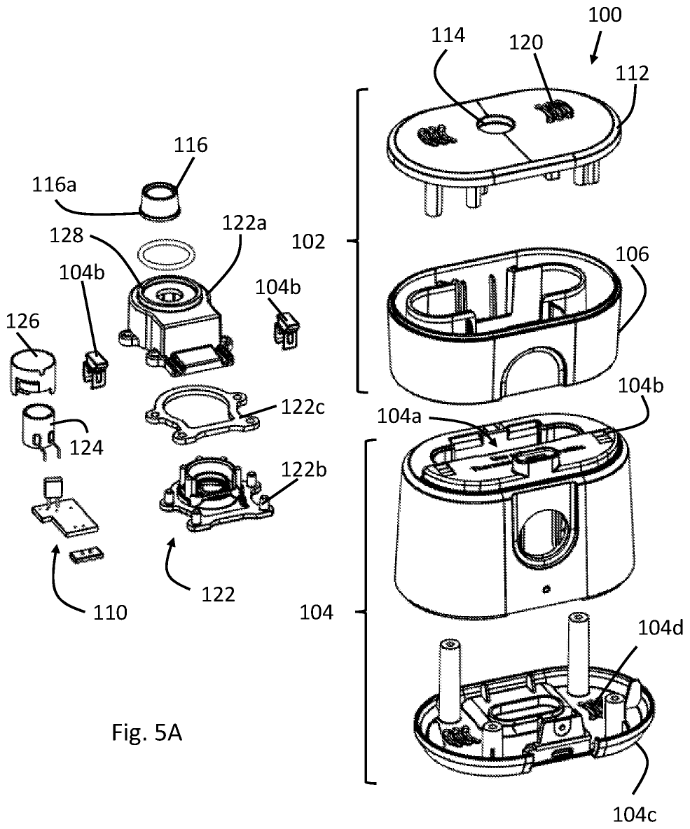

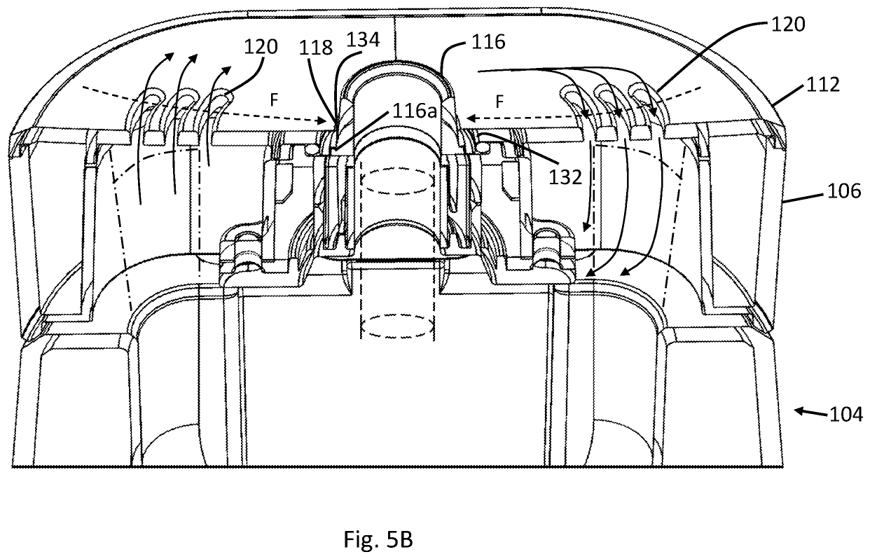

Referring now to FIGS. 5A and 5B, there is illustrated another embodiment of an insect repeller device, shown generally at 100. The insect repeller device 100 includes a lid section 102 and a base section 104. The base section 104 is similar to base section 56 and includes a receiver 104a to support a fluid bottle similar to bottle 16 and further includes attachment points 104b in the form of permanent magnets and corresponding ferrous buttons carried by the lid section 102 to retain the lid section to the base section. The base section 104 may also include a bottom support 104c. In certain embodiments the bottom support 104c or any portion of the base section 104 may include one or more vents 104d to assist in regulating the temperature of the bottle and the fluid contents therein. As the unit is used or exposed to hot ambient conditions, the release rate of the active ingredients in the fluid may increase beyond the desired rate. The vents 104d permit convective air currents to control thermal exposure of the bottle 16.

The lid section 102 includes a lower support 106 that houses a heating assembly, shown generally at 108, retains the bottle 16 within the base section 104, and completes an electrical circuit with a controller 110 to operate the heating assembly similar to the other embodiments described herein. The lid section 102 also includes an upper cap 112 that interacts with the heating assembly 108 to control condensate development on surfaces or in areas where material can spill or come into contact with users or other articles. The upper cap 112 includes an exhaust port 114 that encircles a chimney 116 of the heating assembly 108 and defines a condensate drainage path 118 therebetween. As shown in FIG. 5B, the upper cap 112 is sloped in a direction F toward the drainage path 118 to facilitate flow of condensate toward the chimney 116 and back to the heating assembly 108 and the wick (shown in dashed lines). The upper cap 112 may include one or more vents 120 to aid in both directing emitted vapors that gravitate toward the cooler portions of the upper cap to the heating assembly and wick and/or permitting convective air currents to stabilize the temperature gradient across the upper cap 112.

The heating assembly 108 includes a housing 122, shown as an upper housing 122a, a lower housing 122b and a sealing element or gasket 122c. A heating element 124 and a thermal reflecting collar 126 are supported between the upper and lower housings 122a and 122b, respectively. The upper housing 122a includes a seal retainer and cap support 128 that positions a sealing member 130, such as an O-ring or other seal, against the underside of the upper cap 112. The support 128 and sealing member 130 cooperate to close off a pathway from the drainage path 118 into the lower support 106 and direct condensate and vapors toward the heating element 124 and wick. The sealing member 130 may further be retained by a support leg 132 that extends from the upper cap 112 toward the upper housing 122a and coaxially oriented around the exhaust port 114. The support leg 132 is spaced away to provide a lip 134 that overlaps a flange 116a extending from a base of the chimney 116 as a retainer.

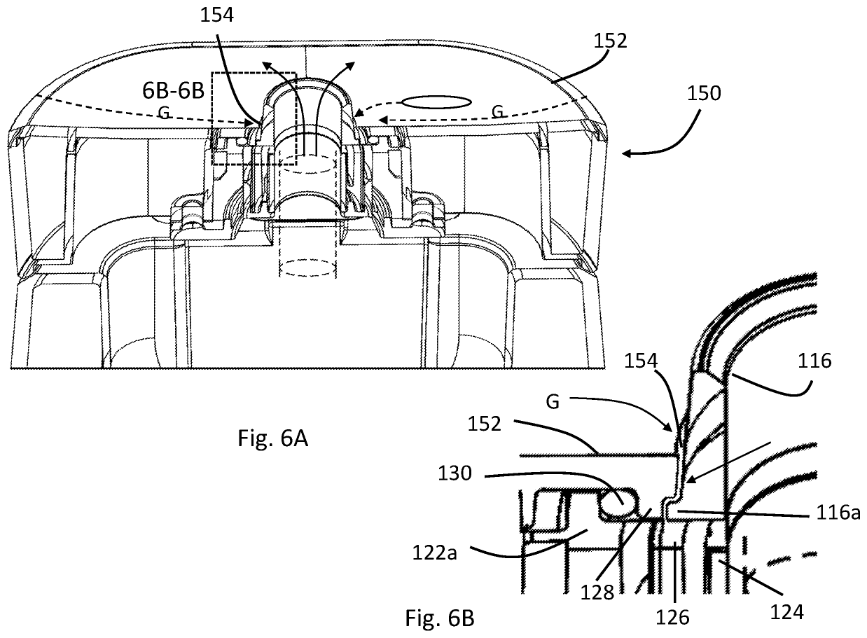

Referring now to FIGS. 6A and 6B, there is illustrated another embodiment of an insect repeller device, shown generally at 150, which highlights a variation of the repeller device 100 described above. The repeller 150 includes the heating assembly 108 with the sealing and seal retaining structures described above. An upper cap 152 attaches to the lower housing 122b and provides an upper surface having a slope G that drains condensate to a drainage path 154, similar in orientation and function to the drainage path 118. Thus, accumulated condensate is further restricted from entering any portion of the lower section 122b.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An insect repelling device comprising:
a base configured to support a fluid reservoir, the fluid reservoir configured to contain an insect repelling fluid; and
a cap having an exhaust port that permits a vapor of the insect repelling fluid to be emitted, the cap configured to permit a condensate of the insect repelling fluid to flow toward the exhaust port.

2. The insect repelling device of claim 1 wherein a wick extends from the fluid reservoir to a heating element, the heating element configured to vaporize the insect repelling fluid from the wick.

3. The insect repelling device of claim 2 wherein a chimney is positioned between the heating element and the cap and extends through the exhaust port to define a condensate drainage path to one of the wick or the heating element.

4. The insect repelling device of claim 3 wherein an upper surface of the cap is sloped toward the exhaust port.

5. The insect repelling device of claim 2 wherein the cap includes at least one opening configured to permit a condensate of the insect repelling fluid to flow toward at least one of the wick or the heating element.

6. The insect repelling device of claim 2 wherein the heating element includes a heater housing having an exhaust extension that extends coaxially through the exhaust port.

7. The insect repelling device of claim 6 wherein a chimney is coaxially positioned within the exhaust extension and cooperates with the exhaust extension to define a condensate drainage path in communication with the wick.

8. The insect repelling device of claim 7 wherein the cap has a generally concave shape that includes at least one opening configured to permit a condensate of the insect repelling fluid to flow toward at least one of the wick or the heating element.

9. An insect repelling device comprising:
a base configured to support a fluid reservoir, the fluid reservoir containing an insect repelling fluid and a wick extending from the fluid reservoir; and
an upper section having a heating assembly and cap with an exhaust port that permits a vapor of the insect repelling fluid to be emitted, the cap defining a condensate drainage path between the heating assembly and the exhaust port to permit a condensate of the insect repelling fluid to flow toward the exhaust port.

10. The insect repelling device of claim 9 wherein the heating assembly includes an exhaust extension extending from a heater housing through the exhaust port, the exhaust extension including an edge radius and a bore, the cap defining a concave, sloped surface extending toward the exhaust port.

11. The insect repelling device of claim 9 wherein the cap defines a concave, sloped surface extending toward the exhaust port, a chimney is coaxially positioned above the wick and extending through the exhaust port, the chimney and the exhaust port defining the condensate drainage path.

12. The insect repelling device of claim 11 wherein the chimney includes a flange that cooperates with the cap to retain the chimney to the upper section.

13. The insect repelling device of claim 12 wherein a sealing element extends between the cap and a portion of the heating assembly to prevent the condensate from migrating away from the wick.
